(19) United States
(12) Patent Application Publication
(10) Pub. No.: US 2017/0335565 A1
(43) Pub. Date: Nov. 23, 2017

(54) Construction Panel Having Improved Fixing Strength

(71) Applicant: Saint-Gobain Placo SAS, Suresnes (FR)

(72) Inventors: Laura Brooks, Loughborough (GB); Nicola Jupp, Coventry (GB); Joanna Sparkes, Coventry (GB); Adam Richardson, Coventry (GB); Nicolas Jones, Coventry (GB); Jan Rideout, Rothley (GB)

(73) Assignee: Saint-Gobain Placo SAS, Suresnes (FR)

(21) Appl. No.: 15/523,966

(22) PCT Filed: Nov. 19, 2015
(86) PCT No.: PCT/GB2015/053538

§ 371 Date: May 3, 2017

(30) Foreign Application Priority Data
Nov. 20, 2014 (GB) 1420674.2

(51) Int. Cl. E04C 2/04; C04B 24/26; C04B 24/38; C04B 14/42; C04B 111/00

(52) U.S. Cl. CPC E04C 2/043; C04B 24/383; C04B 14/42; C04B 24/2623; C04B 2111/0062

(57) ABSTRACT

A gypsum product has a first polymeric additive and a second polymeric additive distributed therein, wherein the first polymeric additive is a synthetic polymer and the second polymeric additive is starch. It has been found that the combination of starch and a synthetic polymer may result in one or more of the following advantages in the manufacture and performance of gypsum products: —increased strength; —greater ease of manufacturing due to the increased fluidity of stucco slurries containing both additives; and —increased resistance to hygroscopic expansion.

### FIELD OF THE INVENTION

The present invention relates to panels for use in building construction. In particular, the present invention relates to panels for providing partitions to which items such as sinks, televisions, or radiators may be affixed.

### BACKGROUND TO THE INVENTION

Light-weight panels such as plasterboard (e.g. gypsum plasterboard), polystyrene board and fibreboard are commonly used to provide partitions within buildings. Their advantages for this application include the fact that they are light and quick to install.

However, in certain cases, such light-weight panels may have the drawback that they are not strong enough to support fixtures (e.g. sinks, televisions, radiators, fire extinguishers, shelves and any other item that requires attachment to the panel). In such cases, the weight of the fixture may cause the fixing means (e.g. screws) to be pulled out of the panel, such that the fixture falls away from the partition.

Typically, this problem has been addressed by providing plywood sheets to increase the fixing strength of the panel. In this case, the plywood sheet is provided on the side of the panel opposite to that on which the fixture is to be located. The plywood sheet may provide increased strength for retaining one or more fixing means (e.g. screws) employed to secure the fixture to the panel. Typically, the plywood sheet is positioned within the partition framework, and the plasterboard then fixed to the plywood, so that it lies outside the partition framework.

As an alternative, metal support means may be provided. These may comprise fixing plates, channels, straps, or metal fasteners. As is the case for plywood sheets, the metal support means are generally positioned on the side of the panel opposite that to which the fixture is to be secured, and act to receive and secure fixing means, e.g. fixing screws, that are used to attach the fixture to the panel.

Both these arrangements have the disadvantage that they require the panels and the additional supporting components to be affixed to each other on-site. Moreover, when metal support means are used, a plurality of such support means may be needed to support the full set of fixing means required to secure the fixture to the panel. Thus, the installation process may be time-consuming and expensive.

Furthermore, the addition of metal support means or plywood sheets increases the weight and thickness of the partition, and/or results in a reduction in cavity wall space. In general, the plywood itself must be cut to size on site, thus increasing the time required for installation and possibly leading to the release of dust and potentially harmful components.

Therefore, there is a need to provide improved panels that are able to retain fixing means and support fixtures, and that do not require time-consuming installation processes.

### SUMMARY OF THE INVENTION

Investigations have been carried out into the use of polymeric additives to strengthen gypsum products. Surprisingly, it has been found that by using a combination of starch and a synthetic polymer, certain advantages in the manufacture and performance of gypsum products may be achieved.

Therefore, in a first aspect, the present invention may provide a gypsum product comprising a first polymeric additive and a second polymeric additive distributed therein, wherein the first polymeric additive is a synthetic polymer and the second polymeric additive is starch.

It has been found that the combination of starch and a synthetic polymer may result in one or more of the following advantages in the manufacture and performance of gypsum products:
increased strength;
greater ease of manufacturing due to the increased fluidity of stucco slurries containing both additives; and
increased resistance to hygroscopic expansion.

Typically, the first polymeric additive is present in an amount equal to or greater than the second polymeric additive. However, in certain cases, the first polymeric additive may be present in an amount than is less than 40% of the total amount of the first and second additives, possibly less than 30%.

In general, the total amount of the first and second polymeric additives is greater than 3 wt % relative to the gypsum, preferably greater than 4 wt %. Typically, the total amount of the first and second polymeric additives is less than 15 wt % relative to the gypsum, preferably less than 13 wt %.

Preferably, the starch is present in an amount of 1.0% or more, relative to the weight of the gypsum product, preferably 1.25 wt % or more, more preferably 2.0 wt % or more.

Preferably, the first polymeric additive is polyvinyl acetate.

The starch may be derived from wheat, potato, tapioca, or corn, for example. Preferably, the starch is derived from corn. In certain embodiments, the starch is a native starch (that is, an unmodified starch). In other embodiments, the starch may be a modified starch, for example, an acid-thinned starch.

In certain embodiments, the starch is a substituted starch, such as described in U.S. Pat. No. 7,048,794, which is hereby incorporated by reference. Substituted starches are starch derivatives that have been chemically reacted to replace one or more of the hydroxyl functional groups. Typically, the process involves etherification or esterification of a starch or modified starch which appends ether or ester linkages along the starch polymer backbone. This process is distinct from other modifications typically made to starches such as oxidization, acid-thinning, cross-linking, and pre-gelatinisation, although such processes may also be applied to the starch, prior to or after substitution with one or more types of functionalities.

It is thought that substituted starches act as efficient binders for the inorganic phase of plasterboards, e.g. gypsum, thus increasing the core strength of the plasterboard. Preferably, the starch is insoluble in cold water, but dissolves at a higher processing temperature during forming, setting, or drying of the plasterboard. This is thought to limit excessive migration of the starch, so that it remains in the plasterboard core, to provide a binder for the gypsum crystals.

The substituted starch may comprise hydroxyethylated, hydroxypropylated, and/or acetylated starch. Preferably, the starch is a hydroxyethylated starch.

The starch may be a migratory starch or a non-migratory starch. Non-migratory starches are starches that are retained within the core of the plasterboard and do not migrate to the board surface. By contrast, migratory starches typically migrate to the surface of the plasterboard and serve the purpose of improving the bonding of the plasterboard core to the paper facing (if used).

An example of a non-migratory starch that may be used in the present invention is dextrin.

Preferably, in the case that the starch is present at a level of at least 3 wt % relative to the gypsum, the starch is a migratory starch. Surprisingly, it has been found that at these relatively high starch contents, even a migratory starch will be retained within the plasterboard core in sufficient amounts so as to enhance the fixing strength of the plasterboard. At the same time, the migratory starch may aid in improving the bonding of the plasterboard core to a paper facing (if used), so that there is no need to include multiple starch varieties within the plasterboard.

In the case that the starch is present at a level of at least 3 wt % relative to the gypsum, it is generally preferred that the starch is a native starch, rather than a pre-gelatinised starch. At these relatively high starch levels, pre-gelatinised starch is considered to impart excessive viscosity to the gypsum slurry.

In other cases, the starch may be a pre-gelatinised starch.

In certain embodiments, the starch may be selected to have a low viscosity (e.g. a Brookfield viscosity of less than 60 cps) at a temperature of less than 60° C., and a much higher viscosity (e.g. a Brookfield viscosity of over 10000 cps) at a temperature of 70° C. Such starches are described in e.g. U.S. Pat. No. 8,252,110, which is hereby incorporated by reference. These starches have a rheology that is strongly temperature-dependent: it is thought that, at low temperatures, the starch may be dispersed in the core in order to penetrate into the inter-crystalline spaces. As soon as the temperature is above 60° C., the viscosity of the starch increases rapidly up to a very high level to ensure that the starch actually remains in the core and does not migrate to the core/facing interface.

In certain cases, the starch may be incorporated into the gypsum product by adding flour (for example, wheat flour) to the stucco slurry.

Preferably, the gypsum product includes fibres embedded therein. Typically, the fibres are present in an amount greater than 2 wt % relative to the gypsum, preferably greater than 3 wt %. Typically, the fibres are present in an amount less than 10 wt % relative to the gypsum preferably less than 7 wt %. In general, the fibres are glass fibres.

Preferably, the gypsum product is substantially free of boron. Boron additives are considered to represent a risk to health and safety during manufacture of the gypsum product.

In certain embodiments, the gypsum product is a plasterboard. In general, the plasterboard has paper facings. These paper facings may comprise both cellulose fibres and glass fibres, as this is thought to improve the fire resistance of the plasterboard. In other cases, the plasterboard may have a mat partially or fully embedded at its surface, for example, a glass mat.

In certain embodiments, the gypsum product comprises a hydrophobic additive, such as silicone oil or wax.

In certain embodiments, the gypsum product may contain a biocide.

In certain embodiments, the gypsum product may contain an anti-shrinkage agent such as unexpanded vermiculite, microsilica, and/or clay, in order to improve the fire-resistance of the product.

Certain embodiments may include foam or lightweight aggregate such as perlite. Such additives are known in the art to produce lower-density boards having acceptable thickness.

### DETAILED DESCRIPTION

The invention will now be described by way of example only.

Gypsum plasterboards were prepared using the following general methodology: Stucco and other dry additives were weighed into a bag and shaken to mix them. Water and wet additives were weighed into a bowl. The fibres were weighed, added to the wet additives in the bowl, and mixed together using an electric mixer for 60 s.

The dry powdered additives were added to the wet additives in the bowl and mixed in with the electric mixer for 30 s.

The resultant slurry was sandwiched between two sheets of paper liner and allowed to hydrate for 25 minutes measured from the time of mixing. The board was then dried in an oven for 1 hour at 160° C.

The resulting plasterboards were 15 mm thick.

### Example 1

A gypsum plasterboard was prepared from the following ingredients:
stucco;
polyvinyl acetate in an amount of 6 wt % relative to the stucco (the polyvinyl acetate is available under the trade name Mowilith 51);
starch in an amount of 6 wt % relative to the stucco (the starch is available under the trade name C Flex 03408);
Glass fibres in an amount of 3 wt % relative to the stucco.

### Example 2

A gypsum plasterboard was prepared from the following ingredients:
stucco;
polyvinyl acetate in an amount of 6 wt % relative to the stucco (the polyvinyl acetate is available under the trade name Vinamul 8481);
starch in an amount of 6 wt % relative to the stucco (the starch is available under the trade name C Flex 03408);
Glass fibres in an amount of 3 wt % relative to the stucco.

### Example 3

A gypsum plasterboard was prepared from the following ingredients:
stucco;
polyvinyl acetate in an amount of 2.5 wt % relative to the stucco (the polyvinyl acetate is available under the trade name Vinamul 8481);
starch in an amount of 2.5 wt % relative to the stucco (the starch is available under the trade name Merifilm 102);
Glass fibres in an amount of 5 wt % relative to the stucco.

### Example 4

A gypsum plasterboard was prepared from the following ingredients:
stucco;
polyvinyl acetate in an amount of 3.75 wt % relative to the stucco (the polyvinyl acetate is available under the trade name Vinamul 8481);
starch in an amount of 1.25 wt % relative to the stucco (the starch is available under the trade name Merifilm 102);
Glass fibres in an amount of 5 wt % relative to the stucco.

### Example 5

A gypsum plasterboard was prepared from the following ingredients:
stucco;
polyvinyl acetate in an amount of 6.25 wt % relative to the stucco (the polyvinyl acetate is available under the trade name Mowilith SI);
starch in an amount of 6.25 wt % relative to the stucco (the starch is available from Grain Processing Corporation under the trade name Coatmaster K57F);
Glass fibres in an amount of 3% relative to the stucco

### Example 6

A gypsum plasterboard was prepared from the following ingredients:
stucco;
polyvinyl acetate in an amount of 6 wt % relative to the stucco (the polyvinyl acetate is available under the trade name Vinamul 8481);
starch in an amount of 0.5 wt % relative to the stucco (the starch is available under the trade name Merifilm 102);
Glass fibres in an amount of 2 wt % relative to the stucco

### Example 7

A gypsum plasterboard was prepared from the following ingredients:
stucco;
polyvinyl acetate in an amount of 0.5 wt % relative to the stucco (the polyvinyl acetate is available under the trade name Vinamul 8481);
starch in an amount of 6 wt % relative to the stucco (the starch is available under the trade name Merifilm 102);
Glass fibres in an amount of 2 wt % relative to the stucco

### Example 8

A gypsum plasterboard was prepared from the following ingredients:
stucco;
polyvinyl acetate in an amount of 4.5 wt % relative to the stucco (the polyvinyl acetate is available under the trade name Vinamul 8481);
starch in an amount of 1.5 wt % relative to the stucco (the starch is available under the trade name Merifilm 102);
Glass fibres in an amount of 2 wt % relative to the stucco

### Example 9

A gypsum plasterboard was prepared from the following ingredients:
stucco;
polyvinyl acetate in an amount of 1.5 wt % relative to the stucco (the polyvinyl acetate is available under the trade name Vinamul 8481);
starch in an amount of 4.5 wt % relative to the stucco (the starch is available under the trade name Merifilm 102);
Glass fibres in an amount of 2 wt % relative to the stucco

### Comparative Example 1a

A gypsum plasterboard was prepared from the following ingredients:
stucco;
starch in an amount of 12 wt % relative to the stucco (the starch is available under the trade name C Flex 03408);
Glass fibres in an amount of 3 wt % relative to the stucco.

### Comparative Example 3a

A gypsum plasterboard was prepared from the following ingredients:
stucco;
starch in an amount of 5 wt % relative to the stucco (the starch is available under the trade name Merifilm 102);
Glass fibres in an amount of 5 wt % relative to the stucco.

### Comparative Example 5a

A gypsum plasterboard was prepared from the following ingredients:
stucco;
starch in an amount of 12.5 wt % relative to the stucco (the starch is available from Grain Processing Corporation under the trade name Coatmaster K57F);
Glass fibres in an amount of 3% relative to the stucco

### Fluidity

Slump diameter was measured as an indicator of fluidity of stucco slurry that was used in the production of the plasterboards. The procedure was carried out in line with British Standard EN13963. The diameter was measured before the slurry was subjected to mechanical vibration. The results are set out in Table 1.

TABLE 1

| Example | Slump diameter |
|---|---|
| Example 1 | 102 mm |
| Example 2 | 102 mm |
| Comparative example 1a | 95 mm |

Expansion with Humidity

Expansion with humidity was measured according to ASTM D1037 from initial conditions of 23° C. and 50% relative humidity to final conditions of 20° C. and 90% relative humidity. The samples were 200 mm long and 50 mm thick. The results are set out in Table 2.

TABLE 2

| Example | Expansion with humidity |
|---|---|
| Example 3 | 0.024 |
| Example 4 | 0.018 |
| Comparative example 3a | 0.034 |

### Screw Pull-Out Strength

Screw pull-out tests were carried out on samples measuring 100 mm by 100 mm that had been conditioned at a temperature of 23° C. and a relative humidity of 50%. A 50 mm single thread wood screw was inserted into the sample, passing through a metal load transfer element positioned on the surface of the sample. The load transfer element has a first portion that is configured to lie between the screw head and the surface of the sample, and a second portion that is configured to engage with a testing machine so as to allow a load to be applied to the screw along the axis of the screw. The screw was tightened to a torque of 1 Nm.

The specimen was then mounted in a Zwick Universal Testing Machine and a 10N pre-load applied to the screw along the axis of the screw. Subsequently, the load was increased by setting a constant cross-head speed of 10 mm/minute until pull out was achieved.

The results are set out in Table 3. These are averages, each taken from 8 samples.

TABLE 3

| Example | Average screw pull-out strength N |
|---|---|
| Example 3 | 734 |
| Comparative example 3a | 674 |
| Example 5 | 1523 |
| Comparative example 5a | 1283 |
| Example 6 | 797 |
| Example 7 | 688 |
| Example 8 | 783 |
| Example 9 | 604 |

1. A gypsum panel comprising a first polymeric additive and a second polymeric additive distributed therein, wherein the first polymeric additive is a synthetic polymer and the second polymeric additive is starch;
the gypsum panel having fibres embedded therein in an amount of 2-10 wt % relative to gypsum in the gypsum panel;
wherein the total amount of the first and second polymeric additives is greater than 4 wt % relative to the gypsum.

2. A gypsum product according to claim 1, wherein the first polymeric additive is present in an amount equal to or greater than the second polymeric additive.

3. A gypsum product according to claim 1, wherein the total amount of the first and second polymeric additives is 20 wt % or less relative to the gypsum.

4. A gypsum product according to claim 1, wherein the first polymeric additive is polyvinyl acetate.

5. A gypsum product according to claim 1, wherein the second polymeric additive is substituted starch.

6. A gypsum product according to claim 5, wherein the starch is ethylated starch.

7. (canceled)

8. A gypsum product according to claim 1, wherein the fibres are glass fibres.

9. A gypsum product according to claim 8, wherein the fibres are present in an amount of 3-10 wt % relative to the gypsum.
